(19) United States
(12) Patent Application Publication
(10) Pub. No.: US 2016/0063380 A1
(43) Pub. Date: Mar. 3, 2016

(54) QUANTIFYING AND PREDICTING HERDING EFFECTS IN COLLECTIVE RATING SYSTEMS

(71) Applicant: International Business Machines Corporation, Armonk, NY (US)

(72) Inventors: Dashun WANG, White Plains, NY (US); Fei WANG, Ossining, NY (US); Ting WANG, White Plains, NY (US)

(21) Appl. No.: 14/484,538

(22) Filed: Sep. 12, 2014

Related U.S. Application Data
(60) Provisional application No. 62/041,869, filed on Aug. 26, 2014.

(51) Int. Cl. G06N 5/04; G06N 7/00

(52) U.S. Cl. CPC G06N 5/04; G06N 7/005

(57) ABSTRACT

Various embodiments quantify herding effects in one or more collective rating systems. In one embodiment, a set of historical rating data associated with at least one rated entity and generated by a collective rating system is obtained. The set of historical rating data at least includes a sequence of ratings and a distribution of ratings in the sequence of ratings at each of a set of rating-levels. An optimal setting for each of a set of parameters and at least one function associated with a prediction-based model is calculated utilizing the set of historical rating data, where each of the optimal settings satisfies an optimization threshold. The prediction-based model is configured with the optimal setting for each of the set of parameters and at least one function. A set of modeling data is generated based on the configured prediction-based model and the set of historical rating data.

### CROSS-REFERENCE TO RELATED APPLICATIONS

This application is based upon and claims priority from prior Provisional Patent Application No. 62/041,869, filed on Aug. 26, 2014, the entire disclosure of which is herein incorporated by reference.

### STATEMENT REGARDING FEDERALLY SPONSORED RESEARCH

This invention was made with Government support under Contract No.: W911NF-06-3-0001 awarded by Army Research Office (ARO). The Government has certain rights in this invention.

### BACKGROUND

The present disclosure generally relates to data processing and modeling, and more particularly relates to quantifying and predicting herding effects in collective rating systems.

In many diverse settings, aggregated opinions of others play an increasingly dominant role in shaping individual decision making. One key prerequisite of harnessing “crowd wisdom” is the independency of individuals' opinions. However, in real settings collective opinions are rarely simple aggregations of independent minds. Recent experimental studies document that disclosing prior collective opinions distorts individuals' decision making as well as their perceptions of quality and value, highlighting a fundamental disconnect from most (if not all) current modeling efforts.

### BRIEF SUMMARY

In one embodiment, a method for quantifying herding effects in one or more collective rating systems is disclosed. The method comprises obtaining a set of historical rating data associated with at least one rated entity and generated by a collective rating system. The set of historical rating data at least comprises a sequence of ratings and a distribution of ratings in the sequence of ratings at each of a set of rating-levels. An optimal setting for each of a set of parameters and at least one function associated with a prediction-based model is calculated utilizing the set of historical rating data, where each of the optimal settings satisfies an optimization threshold. The prediction-based model is configured with the optimal setting for each of the set of parameters and at least one function. A set of modeling data is generated based on the configured prediction-based model and the set of historical rating data.

In another embodiment, an information processing system for quantifying herding effects in one or more collective rating systems is disclosed. The information processing system comprises memory and at least one processor communicatively coupled to the memory. The information processing system also comprises a data processor that is communicatively coupled to the memory and processor. The data processor is configured to perform a method. The method comprises obtaining a set of historical rating data associated with at least one rated entity and generated by a collective rating system. The set of historical rating data at least comprises a sequence of ratings and a distribution of ratings in the sequence of ratings at each of a set of rating-levels. An optimal setting for each of a set of parameters and at least one function associated with a prediction-based model is calculated utilizing the set of historical rating data, where each of the optimal settings satisfies an optimization threshold. The prediction-based model is configured with the optimal setting for each of the set of parameters and at least one function. A set of modeling data is generated based on the configured prediction-based model and the set of historical rating data.

In yet another embodiment, a computer program product for quantifying herding effects in one or more collective rating systems. The computer program product comprises a storage medium readable by a processing circuit and storing instructions for execution by the processing circuit for performing a method. The method comprises obtaining a set of historical rating data associated with at least one rated entity and generated by a collective rating system. The set of historical rating data at least comprises a sequence of ratings and a distribution of ratings in the sequence of ratings at each of a set of rating-levels. An optimal setting for each of a set of parameters and at least one function associated with a prediction-based model is calculated utilizing the set of historical rating data, where each of the optimal settings satisfies an optimization threshold. The prediction-based model is configured with the optimal setting for each of the set of parameters and at least one function. A set of modeling data is generated based on the configured prediction-based model and the set of historical rating data.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a graphical representation of a prediction-based model that describes the likelihood of observing a level-k rating given an entity's rating history according to one embodiment of the present disclosure;

FIG. 3 shows one example of pseudo code for a model inference process that calculates optimal settings for the prediction-based model of FIG. 2 according to one embodiment of the present disclosure;

FIG. 4 shows one example of pseudo code for an out-of-sample extension process according to one embodiment of the present disclosure;

FIG. 5 shows one example of pseudo code for a rating growth prediction process according to one embodiment of the present disclosure;

FIG. 6 shows statistics associated with a rating dataset;

FIG. 7 shows the accuracy of short-term prediction versus the length of rating history used for training various prediction models for multiple product categories;

FIG. 8 shows the accuracy of long-term prediction versus the length of rating history used for training various prediction models for multiple product categories;

FIG. 9 shows an estimated magnitude ƒ(n) for multiple product categories;

FIG. 10 shows heat maps of parameters {θ_{k,k′}} for multiple product categories;

FIG. 11 shows the cumulative proportion of products versus the difference between intrinsic and external average ratings for multiple product categories;

FIG. 12 shows the dynamics of the average external ratings of two sample products;

FIG. 13 shows concrete example of a what-if analysis incorporating artificial conditions into the prediction model of one or more embodiments of the present disclosure;

FIG. 14 shows the average execution time per product by the prediction model of one or more embodiments in model inference and rating prediction;

FIG. 15 is an operational flow diagram illustrating one example of a process for quantifying herding effects in one or more collective rating systems according to one embodiment of the present disclosure; and

FIG. 16 is a block diagram illustrating one example of an information processing system according to one embodiment of the present disclosure.

### DETAILED DESCRIPTION

With the explosive growth of information, our decisions are increasingly relying on aggregated opinions contributed by others, with the belief that the aggregations over a large population can successfully harness the “wisdom of crowds”. Many studies have shown that collective opinions of a group are often closer to the truth than the answer of an individual to a question. While the crowd wisdom applies usefully to a spectrum of domains, ranging from product or service recommendation and crowdsourcing to stock markets and political elections, one key prerequisite of harnessing the crowd wisdom is the independency of individuals' opinions. Most (if not all) individuals are exposed to others' opinions before forming and expressing their own. For example, individuals go to the theater after checking reviews of the movies online; download songs from the hit list; purchase products or go to restaurants after researching what others think about them; etc. As a result, the market does not simply aggregate pre-existing individual preferences, but rather creates an environment rich in social influence.

Recent studies offer convincing evidence that social influence exerts important but counterintuitive effects on collective judgment. These studies demonstrate that disclosing prior collective opinions distorts individuals' decision making and their perceptions of quality and value. Herding effects are created that are irrational and pervasive, yet consequential to market outcome. Despite the significance of these results in experimental settings, quantitative frameworks generally do not exist for modeling model social influence and its impact on systems that are constantly evolving. Models on collective intelligence, from majority voting to collaborating filtering to crowdsourcing all assume independent crowds, thereby representing a critical gap between modeling frameworks and empirical insights.

Therefore, one or more embodiments provide a mechanistic framework to model social influence of prior collective opinions (e.g., product ratings) on subsequent individual decisions, referred to herein as the Herding Effect Aware Rating Dynamics Model (Heard). Embodiments of the present disclosure successfully capture the dynamics of rating growth across different product categories, allowing social biases introduced by prior ratings to be separated from the true values inherent to products. These embodiments not only effectively detect the presence of social biases and gauge less biased values for any given product, but also accurately predict the long-term cumulative growth of ratings through a scalable estimation model solely based on early rating trajectories. As a result, the embodiments of the present disclosure generate testable predictions of collective response to artificial manipulations in rating systems, assisting in further testings through more systematic experiments. The quantitative framework of one or more embodiments, which models social influence biases introduced from prior opinions, is of fundamental importance to studies of social processes; promotes new strategies in untangling manipulations and biases within social environments; and provides significant insights towards design of platforms that aggregate individual opinions from electoral polling to market analysis to product recommendation.

Operating Environment

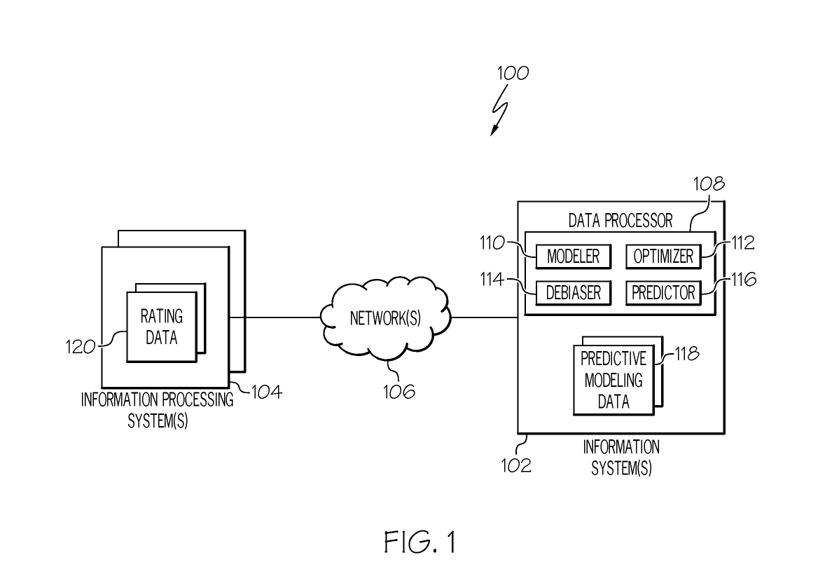

FIG. 1 shows one example of an operating environment 100 according to one embodiments of the present disclosure. In the example shown in FIG. 1, the operating environment 100 comprises a plurality of information processing systems 102, 104. Each of the information processing systems 102, 104 is communicatively coupled to one or more networks 106 comprising connections such as wire, wireless communication links, and/or fiber optic cables. At least one information processing system comprises a data processor 108. The data processor 108 comprises a modeler 110, an optimizer 112, a debiaser 114, and a rating growth predictor 116.

As will be discussed in greater detail below, the data processor 108 obtains a set of rating data 120 (also referred to herein as “rating history 116”) for one or more entities (e.g., products, services, individuals, business, and/or the like). The ratings data 120, in one embodiment, is generated by a rating system and maintained by one or more information processing systems 104. The rating data 120, in one embodiment, comprises an overall rating for the one or more entities; a number of ratings at each rating level of the rating system for the one or more entities; the rating length (number of ratings) for the one or more entities; and/or the like. The data processor 108 analyzes and processes the received rating data 120 and calculates optimal settings for a prediction-based model, which models how the rating data 120 (rating history) influences individual rating behavior for a given rating instance(s). The data processor 108 utilizes this optimally configured model to generate a set of modeling data 118 comprising one or more of debiasing, prediction, and what-if analysis data. With respect to debiasing, the data processor 108 factors out herding effects from collective ratings to identify the intrinsic quality of an entity (e.g., product, service, individual, business, etc.) being rated. With respect to prediction, the data processor 108 predicts the distribution of an entity's next N ratings given its rating history. When performing a what-if analysis, the data processor 108 determines or predicts how an entity's future ratings would be “herded” if M ratings of a given level were injected into the entity's current ratings.

Quantifying and Predicting Herding Effects in Crowd Wisdom Environments

As discussed above, the data processor 108 obtains a set of rating data 120 generated by a rating system and maintained by one or more information processing systems 104. In one embodiment, the rating system is a K-level rating system such as that utilized by most online retailers (e.g., a one-to-five star rating system). The rating data 120 comprises a sequence of ratings for one or more entities. For example, the rating data 120 comprises a sequence of ratings for a specific product, with rᵢ∈{1, 2, . . . , K} being the i-th rating. The first (i−1) ratings form the history for rᵢ:xᵢ=[x_{i,1}, x_{i,2}, . . . , x_{i,K}]^{T}, where x_{i,k} represents the proportion of level-k ratings among the first (i−1) ratings. Clearly, Σₖ₌₁^{K}x_{i,k}=1 for i>1 and x₁ is an all-zero vector. The data processor 108 utilizes such a rating history to generate modeling data showing how the rating history influences individual rating behavior on rᵢ.

The generation of a new level-k rating is driven by multiple factors, including: the intrinsic product quality, the occurrence of preceding level-k ratings, and the history of other ratings. In one embodiment, the modeler 110 of the data processor 108 determines the distribution of the i-th rating rᵢ over different levels according to the following additive generative model (also referred to herein as the “HEARD model”):

$$Pr ( {r}_{i} = k \vert {x}_{i} ) = \frac{exp ( {μ}_{k} + f ( i ) {θ}_{k}^{⊤} {x}_{i} )}{{\sum }_{{k}^{′} = 1}^{K} exp ( {μ}_{{k}^{′}} + f ( i ) {θ}_{{k}^{′}}^{⊤} {x}_{i} )} . \qquad ( EQ 1 )$$

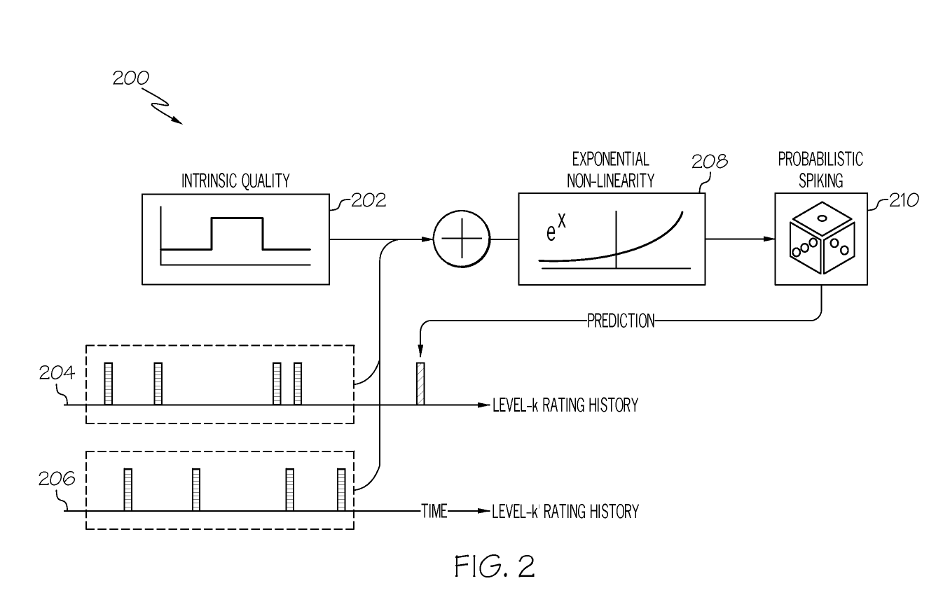

The modeler 110 utilizes EQ 1 to calculate a conditional distribution Pr=(rᵢ=k|xᵢ) that describes the likelihood of observing a level-k rating given rating history xᵢ. In EQ 1 above, μ=[μ₁, μ₂, . . . , μ_{K}]^{T}∈ [symbol] ^{K} represents the coefficients of an intrinsic distribution, which is assumed to be related to the true quality of the product. The function ƒ(•) is a magnitude function, which describes the relationship between the strength of herding effects and the number of historical ratings; in particular, ƒ(1)=0. ƒₖ∈ [symbol] ^{K} weighs the different components of xᵢ. The model data 118 generated by the data processor 108 captures both positive and negative influence. Concretely, when the k′-th component θ_{k,k′}>0, the preceding level-k′ ratings excite the occurrence of level-k ratings; while if θ_{k,k′}<0, the level-k′ ratings inhibit the generation of new level-k ratings. The modeler 110 integrates the above factors in an exponential function as shown in FIG. 2. In particular, FIG. 2 shows an illustrative example of the HEARD model 200 with inputs of intrinsic quality 202, level-k rating history 204, and rating history length 206. The inputs are integrated into an exponential function 208 where probabilistic spiking 210 is utilized to predict a new level-k rating.

Throughout the following discussion, let Θ=[θ₁, θ₂, . . . , θ_{K}, μ] represent all the parameters with unknown settings/values. Both Θ and magnitude function ƒ(•) are estimated from data, with ƒ(•) being estimated from an infinite dimensional functional space. Regarding a specific product, a temporally ordered sequence of N ratings {rᵢ}ᵢ₌₁^{N} is observed. It should be noted that although the following discussion is directed to a single product for ease of presentation, the extension to multiple products is straightforward. For notational simplicity, a set of indicator variables is introduced: yᵢ∈{0,1}^{K} with y_{i,k}=1 it r⁽ⁱ⁾=k and 0 otherwise. Then, the log-likelihood of parameters Θ given this rating sequence is expressed as:

$$ℒ ( Θ ) = \frac{1}{N} log {\prod }_{i = 1}^{N} Pr ( {r}_{i} \vert {x}_{i} , Θ ) = \frac{1}{N} {\sum }_{i = 1}^{N} {\sum }_{k = 1}^{K} {y}_{i , k} log \frac{exp ( {μ}_{k} + {f}_{i} {Θ}_{k}^{⊤} {x}_{i} )}{{\sum }_{{k}^{′} = 1}^{K} exp ( {μ}_{{k}^{′}} + {f}_{i} {Θ}_{{k}^{′}}^{⊤} {x}_{i} )}$$

The modeler 110 estimates the model parameters by minimizing the penalized log-likelihood function, which is defined as:

$${ℒ}_{λ} ( Θ ) = - ℒ ( Θ ) + \frac{λ}{2} ( {‖ Θ ‖}_{F}^{2} + ℛ ( f ) ) , \qquad ( EQ 2 )$$

where the first term represents the negative log-likelihood, the second term is a regularizer with λ being the balance parameter to prevent overfitting, and ∥•∥_{F} denotes the matrix Frobenius norm. In particular, [symbol] (ƒ) is a penalty term preferring smooth functions. Without prior knowledge, [symbol] (ƒ)=∫₀^{∞}(ƒ′(t))²dt is used, where ƒ′(•) represents the derivative of ƒ(•).

While [symbol] _{λ}(Θ) appears similar to the softmax regression; it comprises the integral of an unknown function and meanwhile all the parameters are coupled, which makes it difficult to directly apply off-the-shelf optimization methods (e.g., coordinate descent). Therefore, the optimizer 112 of the data processor 108 performs an iterative optimization process to optimize [symbol] _{λ}(Θ) by (i) constructing a surrogate function to decouple the parameters and (ii) applying an Euler-Lagrange equation to fit the unknown function.

More specifically, let Θ⁽ⁿ⁾=[θ₁⁽ⁿ⁾, θ₂⁽ⁿ⁾, . . . , θ_{K}⁽ⁿ⁾, μ]⁽ⁿ⁾] denote the current parameter setting. The optimizer 112 constructs the following surrogate function [symbol] (Θ; Θ⁽ⁿ⁾), which is a tight upper bound of [symbol] _{λ}(Θ):

$$Q ( Θ ; {Θ}^{( n )} ) = \frac{1}{N} {\sum }_{i} {\sum }_{k} ( {φ}_{i , k}^{2} + ( {β}_{i , k}^{( n )} - 2 {φ}_{i , k}^{( n )} - {y}_{i , k} ) {φ}_{i , k} ) - \frac{1}{NK} {\sum }_{i} ( {\sum }_{k} {φ}_{i , k} - 2 {\sum }_{k} {φ}_{i , k}^{( n )} ) ( {\sum }_{k} {φ}_{i , k} ) + \frac{λ}{2} ( {‖ Θ ‖}_{F}^{2} + ℛ ( f ) ) + \frac{1}{N} {\sum }_{i} {C}_{i}^{( n )} , \qquad ( EQ 3 )$$

where the terms φ_{i,k}, φ_{i,k}⁽ⁿ⁾ β_{i,k}⁽ⁿ⁾ and Cᵢ⁽ⁿ⁾ are defined below:

$${φ}_{i , k} = {μ}_{k} + {f}_{i} {θ}_{k}^{⊤} {x}_{i}$$

$${φ}_{i , k}^{( n )} = {μ}_{k}^{( n )} + {f}_{i}^{( n )} {θ}_{k}^{( n ) ⊤} {x}_{i}$$

$${β}_{i , k}^{( n )} = \frac{exp ( {φ}_{i , k}^{( n )} )}{{\sum }_{{k}^{′}} exp ( {φ}_{i , {k}^{′}}^{( n )} )}$$

$${C}_{i}^{( n )} = {\sum }_{k} ( {φ}_{i , k}^{( n ) 2} - {β}_{i , k}^{( n )} {φ}_{i , k}^{( n )} ) - \frac{1}{K} {( {\sum }_{k} {φ}_{i , k}^{( n )} )}^{2} + log {\sum }_{k} exp ( {φ}_{i , k}^{( n )} ) .$$

It is noted that [symbol] (Θ; Θ⁽ⁿ⁾) possesses the following desirable properties:

$$\{ \begin{matrix}Q ( Θ ; {Θ}^{( n )} ) \geq {ℒ}_{λ} ( Θ ) & ∀ Θ , {Θ}^{( n )} \\ Q ( {Θ}^{( n )} ; {Θ}^{( n )} ) = {ℒ}_{λ} ( {Θ}^{( n )} ) & ∀ {Θ}^{( n )}\end{matrix}$$

which imply that if Θ⁽ⁿ⁺¹⁾=argₘᵢₙ_{_{Θ}} [symbol] (Θ; Θ⁽ⁿ⁾), then [symbol] _{λ}(Θ⁽ⁿ⁾)≧ [symbol] _{λ}(Θ⁽ⁿ⁺¹⁾). Therefore, minimizing [symbol] (Θ; Θ⁽ⁿ⁾) with respect to Oat each iteration ensures that [symbol] _{λ}(Θ) decreases monotonically.

The following proves that the objective function [symbol] _{λ}(Θ) as defined in EQ 2 and its surrogate function [symbol] (Θ; Θ⁽ⁿ⁾) as defined in EQ 3 satisfy the following relationships:

$$\{ \begin{matrix}Q ( Θ ; {Θ}^{( n )} ) \geq {ℒ}_{λ} ( Θ ) & ∀ Θ , {Θ}^{( n )} \\ Q ( {Θ}^{( n )} ; {Θ}^{( n )} ) = {ℒ}_{λ} ( {Θ}^{( n )} ) & ∀ {Θ}^{( n )}\end{matrix}$$

First, according to the definition of EQ 1:

$${ℒ}_{λ} ( Θ ) = \frac{1}{N} {\sum }_{i} ( log {\sum }_{k} exp ( {φ}_{i , k} ) - {\sum }_{k} {y}_{i , k} {φ}_{i , k} ) + \frac{λ}{2} ( {‖ Θ ‖}_{F}^{2} + ℛ ( f ) ) .$$

With respect to the log-sum-exponential term log Σₖexp(φ_{i,k}) the following quadratic upper bound is applied for any vectors u∈ [symbol] ^{K} and v∈ [symbol] ^{K},

$$log {\sum }_{k} exp ( {u}_{k} ) \leq {\sum }_{k} {( {u}_{k} - {v}_{k} )}^{2} - \frac{1}{K} {( {\sum }_{k} ( {u}_{k} - {v}_{k} ) )}^{2} + {\sum }_{k} \frac{exp ( {v}_{k} ) ( {u}_{k} - {v}_{k} )}{{\sum }_{{k}^{′}} exp ( {v}_{{k}^{′}} )} + log {\sum }_{k} exp ( {v}_{k} ) .$$

In one context, the log-sum-exponential term of [symbol] (Θ) with its upper bound and substitute uₖ with φ_{i,k} and vₖ with φ_{i,k}⁽ⁿ⁾, which then leads to the result of [symbol] (Θ; Θ⁽ⁿ⁾)≧ [symbol] _{λ}(Θ). To prove [symbol] (Θ⁽ⁿ⁾; Θ⁽ⁿ⁾)= [symbol] _{λ}(Θ⁽ⁿ⁾), it is noted that the upper bound above is exact when u=v.

The formulation is advantageous since the optimizer 112 can derive the closed form solution of Θ for argₘᵢₙ_{_{Θ}} [symbol] (Θ; Θ⁽ⁿ⁾). Specifically, by deriving the derivatives of [symbol] (Θ; Θ⁽ⁿ⁾) with respect to μₖ and θ_{k,k′} and setting them to zero, the optimizer 112 obtains their update rules for the (n+1)-th iteration as follows:

$$\begin{matrix}{μ}_{k}^{( n + 1 )} = \frac{K {\sum }_{i} ( {y}_{i , k} - {β}_{i , k}^{( n )} ) + 2 N ( K - 1 ) {μ}_{k}^{( n )}}{2 N ( K - 1 ) + NK λ} , & ( EQ 4 ) \\ {θ}_{k , {k}^{′}}^{( n + 1 )} = \frac{K {\sum }_{i} {f}_{i} {x}_{i , {k}^{′}} ( {y}_{i , k} - {β}_{i , k}^{( n )} ) + 2 ( K - 1 ) {\sum }_{i} {f}_{i}^{2} {x}_{i , {k}^{′}}^{2} {θ}_{k , {k}^{′}}^{( n )}}{2 ( K - 1 ) {\sum }_{i} {f}_{i}^{2} {x}_{i , {k}^{′}}^{2} + NK λ} . & ( EQ 5 )\end{matrix}$$

The optimizer 112 derives the updating rule for the magnitude function ƒ(•) by optimizing it in an infinite dimensional functional space. The optimizer 112 extracts the parts of [symbol] (Θ; Θ⁽ⁿ⁾) relevant to ƒ(•) and then reformulates the problem of minimizing [symbol] (Θ; Θ⁽ⁿ⁾) with respect to ƒ(•) as follows:

$${min}_{f ∈ {L}_{1} ( ℝ )} {\sum }_{i} {A}_{i} {f}_{i}^{2} + {\sum }_{i} {B}_{i} {f}_{i} + \frac{λ}{2} {\int }_{0}^{+ ∞} {( {f}^{′} ( t ) )}^{2} d t , \qquad ( EQ 6 )$$

where terms Aᵢ and Bᵢ are defined below:

$${A}_{i} = \frac{1}{N} {\sum }_{k} {( {θ}_{k}^{( n ) ⊤} {x}_{i} )}^{2} - \frac{1}{NK} {( {\sum }_{k} {θ}_{{ }^{k}}^{( n ) ⊤} {x}_{i} )}^{2} , \\ {B}_{i} = \frac{1}{N} {\sum }_{k} ( 2 {μ}_{k}^{( n )} - 2 {φ}_{i , k}^{( n )} + {β}_{i , k}^{( n )} - {y}_{i , k} ) {θ}_{k}^{( n ) ⊤} {x}_{i} + \frac{2}{NK} ( {\sum }_{k} {θ}_{k}^{( n ) ⊤} {x}_{i} ) ( {\sum }_{k} {φ}_{i , k}^{( n )} - {\sum }_{k} {μ}_{k}^{( n )} ) .$$

Stated differently, EQ 6 represents the part of optimization problem relevant to the magnitude function ƒ(•) from which the update rule for ƒ(•) is derived.

Two functions can be introduced: A(t)=Aₜ [symbol] {t≦N [symbol] t∈ [symbol] } and B(t)=Bₜ [symbol] {t≦N [symbol] t∈ [symbol] }, where [symbol] {•} is the indicator function which returns 1 if the predicate is true and 0 otherwise. Then, the solution of the objective function as defined in EQ 6 must satisfy the Euler-Lagrange equation:

2A(t)ƒ(t)+B(t)−λƒ″(t)=0 (EQ7),

where g″(•) is the second order derivate of g(•).

Due to the discrete nature of the functions A(t) and B(t), the optimizer 112 solves this differential equation numerically using a Seidal type iteration. Specifically, the optimizer 112 discretizes the differential equations over intervals of length 1:

λ(ƒᵢ₊₁−2ƒᵢ+ƒᵢ₋₁)−2Aᵢƒᵢ−B₁=0

The optimizer then efficiently solves ƒᵢ for i=1, 2, . . . , N. Curve fitting can be performed to extrapolate the values of ƒᵢ for i>N.

To derive Eqn. (7), it is first noticed that the optimization problem in EQ 6 can be rewritten as:

$${min}_{f ∈ {L}_{1} ( ℝ )} {\int }_{0}^{∞} F ( f , {f}^{′} ) d t ,$$

where F(ƒ, ƒ′) is defined by:

$$F ( f , {f}^{′} ) = {A}_{t} 𝕀 \{ t ∈ ℕ \} {f ( t )}^{2} + {B}_{t} 𝕀 \{ t ∈ ℕ \} f ( t ) + \frac{λ}{2} {( {f}^{′} ( t ) )}^{2} .$$

According to Euler-Lagrange equation, the solution of this problem satisfies the following differential equation:

$$\frac{\partial F}{\partial f} - \frac{d }{d t} \frac{\partial F}{\partial {f}^{′}} = 0.$$

By substituting F with the definition above, we the differential equation in EQ 7 is obtained.

In one embodiment, a proper starting point for optimization is set by considering the degenerated case where the prior ratings have no effect on individual rating behaviors. Under this assumption, the optimizer 112 utilizes the following setting:

$$\{ \begin{matrix}{μ}_{k} = log ( \frac{{\sum }_{i = 1}^{N} {y}_{i , k}}{N} ) & k = 1 , 2 , … , K \\ {f}_{i} = 0 & i = 1 , 2 , … , N ,\end{matrix} \qquad ( EQ 8 )$$

and initializes θ₁, θ₂, . . . , θ_{K} randomly.

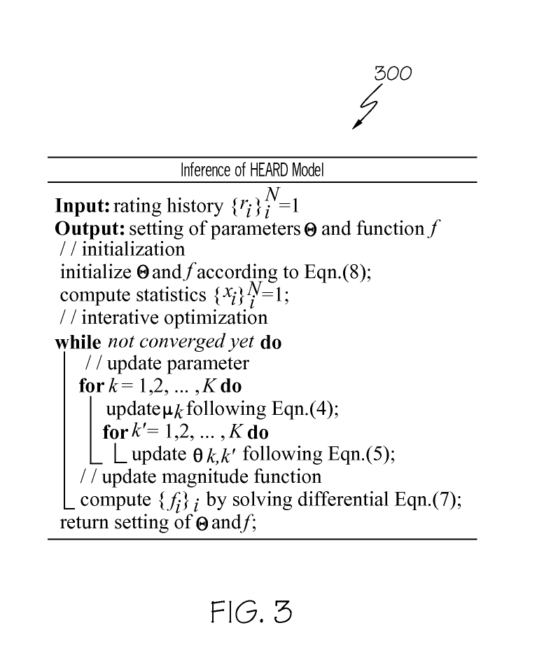

FIG. 3 shows one example of pseudo code 300 for the model inference process performed by the data processor 108 discussed above. In particular, FIG. 3 shows that the data processor 108 obtains a set of rating data 120 (rating history) {rᵢ}ᵢ₌₁^{N} generated by a rating system, and outputs optimized settings (values) for parameters Θ and function ƒ in EQ 1 based on a learning/optimization process. In one embodiment, the data processor 108 obtains its desired output by creating N prediction tasks based on the rating data 120. Each prediction task in the N prediction tasks corresponds to an iteration of the optimization process discussed below.

The data processor 108 initializes Θ and ƒ according to EQ 8. For example, to set the initial values of μ, it is assumed the ratings are generated independently by a multinomial distribution. The parameters of the multinomial distribution correspond to the initial setting of μ\mu. While for ƒ, because it's a discrete function, the initial value of ƒ is set at each point as constant 0. The data processor 108 also computes statistics {xᵢ}ᵢ₌₁^{N}. The statistics here refer to the proportion of different ratings at each stage of the history ratings, e.g., for 100 ratings, x_{—}1, x_{—}2, x_{—}100.

After initialization, the data processor 108 iterates between updating parameters Θ and solving the magnitude function ƒ(•) until the objective function of EQ 2 converges. Stated differently, the data processor 108 updates the parameter Θ and magnitude function ƒ(•) settings until an optimization threshold is satisfied. For example, during the iterative optimization process, the data processor 108 updates parameters Θ by updating μₖ for k=1, 2, K according to EQ 4 and updates θ_{k,k′} for k′=1, 2, K according to EQ 5. In other words, a set of update rules (EQ 4 and EQ 5 for θ and EQ 7 for ƒ) are utilized which at each iteration finds the setting of parameters and function based on their setting in the previous iteration. Then, the data processor 108 computes {ƒᵢ}ᵢ by solving the differential equation in EQ 7 for the current iteration. A setting (value) of Θ and ƒ is then outputted at each iteration until the objective function converges.

Consider one example where the rating data 120 comprises 100 ratings for a given entity. In this example, the data processor 108 creates 100 prediction tasks T. During the first iteration of the optimization process the data processor 108 selects values for Θ and ƒ, and performs a first of the 100 prediction task T₁ according to EQ 1. Stated differently, the selected values for Θ and ƒ are inputted into EQ 1 and the data processor calculates the probability of the first rating r₁ being, for example, a 1-star rating, a 2-start rating, . . . , K-star rating. This output is then compared to the actual rating first rating in the received rating data 120 to determine how close the output of the first iteration matched the actual rating. In one embodiment, EQ 2 is utilized by the data processor 108 to perform this comparison.

If the output (calculated probability of generated rating) of the first iteration fails to be within a given optimization threshold, the data processor updates the values of Θ and ƒ and performs a next iteration of the optimization process. The data processor 108 selects new values for Θ and ƒ by selecting the optimal setting that best explain the given training data. The data processor 108 the probability for each K-level rating for the second of the 100 ratings based on the new values for Θ and ƒ and the previous known rating(s) from the rating data 120. This new output is then compared to the actual rating second rating in the received rating data 120 to determine how close the output of the second iteration matches the actual rating. If the output (calculated probability of generated rating) of the second iteration fails to be within a given optimization threshold, the data processor 118 updates the values of Θ and ƒ and performs the next iteration of the optimization process. This process continues until the output of an iteration matches the rating data 120 within a specified maximum degree (optimization threshold).

Once the optimization threshold has been satisfied, the values for Θ and ƒ that achieved this threshold are fixed to the HEARD model, and the data processor 108 is configured with the optimized model. The data processor 108 is then able to perform one or more analytical operations utilizing the optimized model.

For example, the data processor 108 perform debiasing, prediction, and what-if analysis operations. Regarding debiasing, the data processor 108 is able to determine the intrinsic quality of a product by factoring out the herding effects from its collective ratings. For example, recall that the HEARD model defined in EQ 1 comprises two additive components, namely, the intrinsic distribution and the herding effect distributions. The background intrinsic distribution as controlled by parameters {μₖ} is assumed to be related to the true quality of a product. Therefore, once {μₖ} has been estimated from the rating history of a product, the debiaser 114 of the data processor 108 “debiases” the collective ratings by factoring out the components attributed to the herding effects. For example, let μ=[μ₁, μ₂, . . . , μ_{K}]^{T}. Without the herding effects, each rating is generated by the following unconditional categorical distribution:

$$η = \frac{exp ( μ )}{{\sum }_{k} exp ( {μ}_{k} )} , \qquad ( EQ 9 )$$

which represents the intrinsic rating of the product.

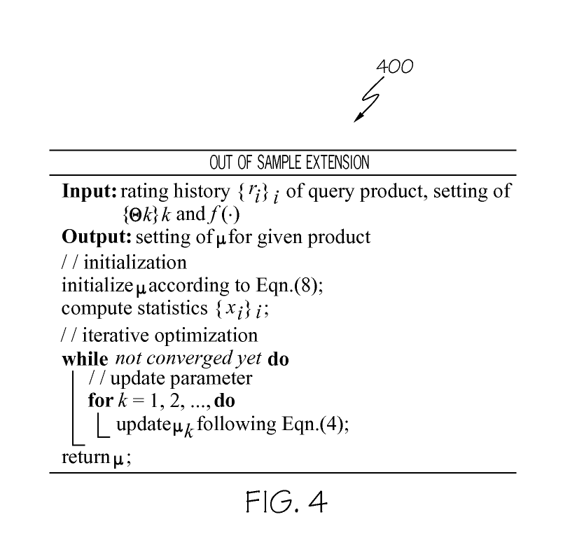

One solution for estimating μ of a given product is to directly fit the model parameters using its rating history as discussed above with respect to FIG. 3. However, this may lead to overfitting. Therefore, and “out-of-sample” extension can be utilized. As will be discussed in greater detail below, the herding effects often follow similar patterns for products of the same category (e.g., books). Therefore, the rating histories of a bulk of products in the same category can be used to train category-level parameters {θₖ} and magnitude function ƒ(•). For the query product, {θₖ} and ƒ(•) are fixed and the data processor 108 focuses on learning product-level parameter μ. FIG. 4 shows pseudo code 400 for an “out-of-sample” extension. As shown in FIG. 4, this procedure is similar to the process discussed above with respect to FIG. 3, except that at each iteration the data processor 108 only needs to update μ.

In addition to debiasing, the data processor 108 also predicts rate growth (distribution of ratings) based on the current rating history of an entity. For example, the data processor 108 trains the prediction model using history rating data to obtain the optimal parameter setting. Then, at each step of given prediction range N, the data processor 108 treats the current prediction as rating history and predict the next ratings. The data processor 108 repeats this process for sufficient number of times and average the results

In more detail, the data processor 108 can receive a request to determine or characterize the distribution of an entity's next M ratings given its first N ratings. In this embodiment, consider the herding effects-agnostic case in which each rating is independently generated by the categorical distribution as defined in EQ 9. Under this assumption, the next M ratings follow a multinomial distribution; specifically, the expected number of level-k rating is given by M [symbol] ₖ with variance M [symbol] ₖ(1− [symbol] ₖ).

Next, the herding effects are incorporated. Recall that the distribution of the first (i−1) ratings is given by xᵢ, which also corresponds to the history for the i-th rating. The transition probability from xᵢ to xᵢ₊₁ can be described as below:

$$Pr ( {x}_{i + 1} = \frac{i - 1}{i} {x}_{i} + \frac{{e}_{k}}{i} \vert {x}_{i} ) = \frac{exp ( {φ}_{i , k} )}{{\sum }_{{k}^{′}} exp ( {φ}_{i , {k}^{′}} )} , \qquad ( EQ 10 )$$

where eₖ is a 1-of-K vector with the k-th element being 1. This transition rule essentially specifies a non-stationary Markov chain in which both the state space and the transition probability change from step to step. This setting is not amenable to exact inference so, in one embodiment, Monte Carlo methods are utilized.

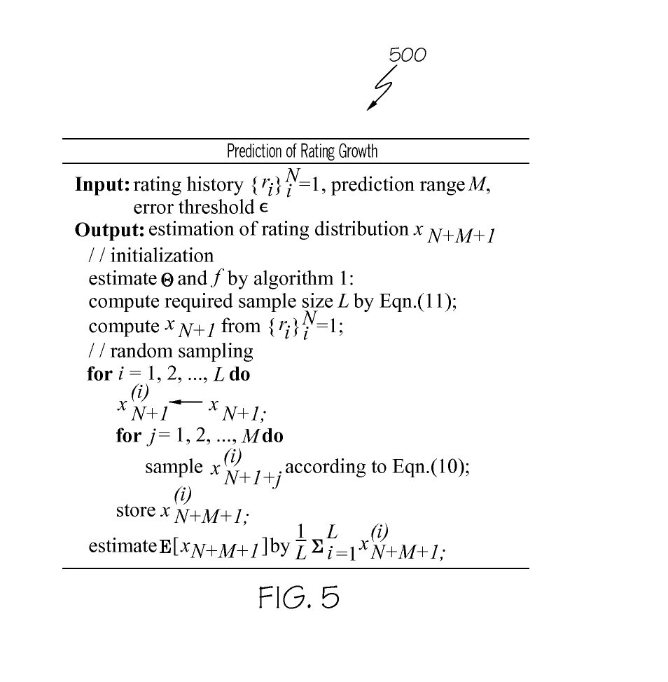

FIG. 5 shows one example of pseudo code 500 describing the rating growth prediction process performed by the data processor 108. In this embodiment, the data processor 108 estimates the current rating distribution x_{N+1} from the given rating data 120. The predictor 116 of the data processor 108 iteratively samples the next rating distribution using the transition rule in EQ 10. Let {x_{N+M+1}⁽ⁱ⁾}ᵢ₌₁^{L} be the set of samples of target distribution x_{N+M+1} and

$${\hat{x}}_{N + M + 1} = \frac{1}{L} {\sum }_{i = 1}^{L} {x}_{N + M + 1}^{( i )}$$

be the expectation of target distribution. For given thresholds ε and δ, if the sample size L satisfies the following condition:

$$L \geq ⌊ \frac{1}{2 {ɛ}^{2}} log \frac{2}{δ} ⌋ , \qquad ( EQ 11 )$$

then |\hat{x}_{N+M+1}−x_{N+M+1}|≦ε1 with probability at least 1−δ, where 1 denotes a K-dimensional all-ones vector. The process shown in FIG. 5 also features the complexity of

$$O ( \frac{1}{{ɛ}^{2}} log ( \frac{1}{δ} ) MK ) ,$$

thereby scaling up to large M.

To derive the number of samples required for the given thresholds ε and δ as in EQ 11 consider, without loss of generality, the k-th element of x_{N+M+1}, x_{N+M+1,k}. Following the Hoeffding's inequality:

$$Pr ( \vert {\hat{x}}_{N + M + 1 , k} - 𝔼 [ {\hat{x}}_{N + M + 1 + k} ] \vert \geq ɛ ) \leq exp ( - \frac{2 {L}^{2} {ɛ}^{2}}{{\sum }_{i = 1}^{L} {( {b}_{i} - {a}_{i} )}^{2}} ) ,$$

where x_{N+M+1,k}⁽ⁱ⁾ is bounded by [aᵢ,bᵢ].
Notice that \hat{x}_{N+M+1} is an unbiased estimator of x_{N+M+1} and x_{N+M+1}⁽ⁱ⁾ is bounded by [0,1]. By setting the right side of the inequality above to δ, EQ 11 is obtained

The data processor 108 is also configured to perform various what-if analysis operations. For example, given the current rating distribution xᵢ, one may arbitrarily change xᵢ to another distribution xᵢ, to reflect any artificial conditions one wishes to “inject” in (e.g., a burst of 50 five-star ratings due to certain promotion campaigns). Staring from this new state xᵢ, and applying the prediction method above, the data processor 108 predicts the trends of future rating growth which allows the consequences of the injected conditions to be gauged. Such what-if analysis is especially valuable for a range of applications including market profitability estimation, budgeted advertising, and fraudulent manipulation detection.

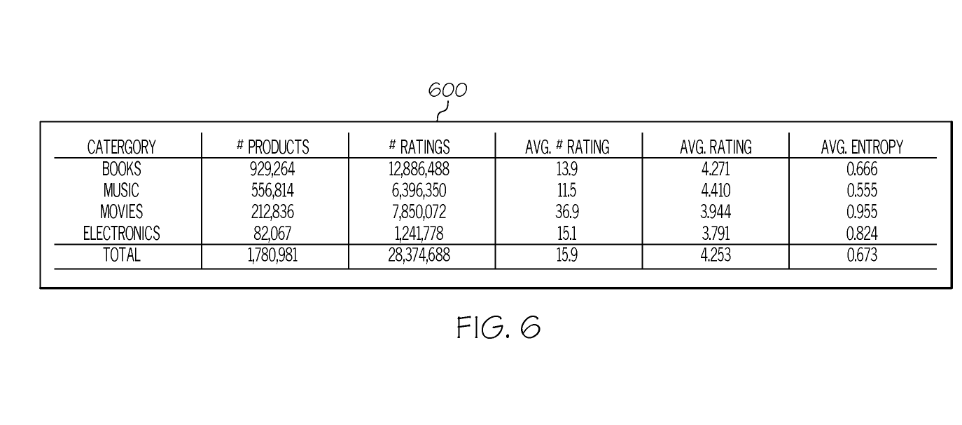

The following discussion illustrates the advantages of one or more embodiments discussed above over various types of models. Different models were evaluated using the real customer rating data collected from an online-retailer, which spans a period of approximately 18 years, including around 35 million ratings regarding about 2.4 million products. In particular, products in four major categories were focused on: Books, Music, Movies, & TV, and Electronics, which cover over 72% of the total number of products in the collection. The statistics 600 of this rating dataset is summarized in FIG. 6. It is noticed that these four categories demonstrate fairly diverse characteristics, for example, with average rating entropy ranging from 0.56 to 0.96.

For comparison purposes, two additional rating growth models were implemented besides the HEARD model: Independent Multinomial Generative model (IMG) and Constant HEARD Model (HEARD_C). IMG is the null hypothesis model, which assumes each new rating is generated according to a fixed multinomial distribution over different rating levels. This multinomial model is estimated from the rating history following the maximum likelihood principle. HEARD_C is a simplified variant of HEARD, which follows the definition of EQ 1, except that the magnitude function is set as ƒ(x)=1 for x>1; that is, it assumes the strength of herding effects stays constant regardless of the cumulative number of ratings. All the models and associated algorithms were implemented in Matlab and the experiments were conducted on a Linux box running 3.5 GHz Intel i7 CPU and 16 GB RAM. The default parameter setting is: λ=1, δ=0.05, and ε=0.01.

A first set of experiments were performed to evaluate the validity of different rating growth models. For each product in the dataset, its temporally ordered sequence of ratings were partitioned into two subsequences as the training (i.e., rating history) and testing parts respectively. The rating history was used to train the rating growth models and let them predict the “future” ratings in the testing set. The accuracy of the growth models were compared in both short-term and long-term prediction.

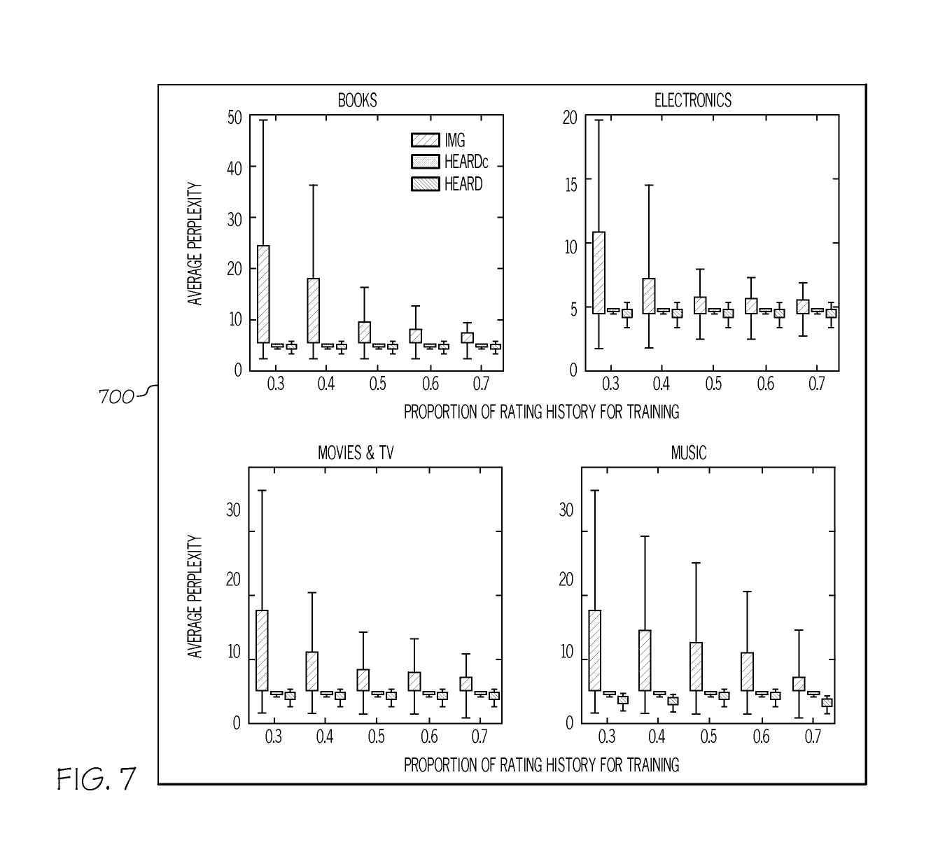

With respect to short-term prediction, the length of rating history was varied (as the proportion of the entire rating sequence of a product) and the average perplexity of the prediction of the next 50 ratings by different models was measured. The results 700 are shown in FIG. 7. It is noticed that across all four product categories, HEARD and HEARD_C outperform IMG in terms of prediction accuracy. In particular, when only limited data (e.g., 30%) is available for training, the accuracy of IMG can be arbitrarily bad. This is attributed to the fact that the prediction of IMG relies on the overall statistics of the rating history of each product, which has not emerged yet at this early stage. In contrast, HEARD leverages the rating histories of all the products in the same category to fit the model, thereby achieving high accuracy even when facing limited training data. This desirable property makes HEARD is especially valuable for early-stage prediction, discussed below. It is also noticed that HEARD achieves higher accuracy than HEARD_C.

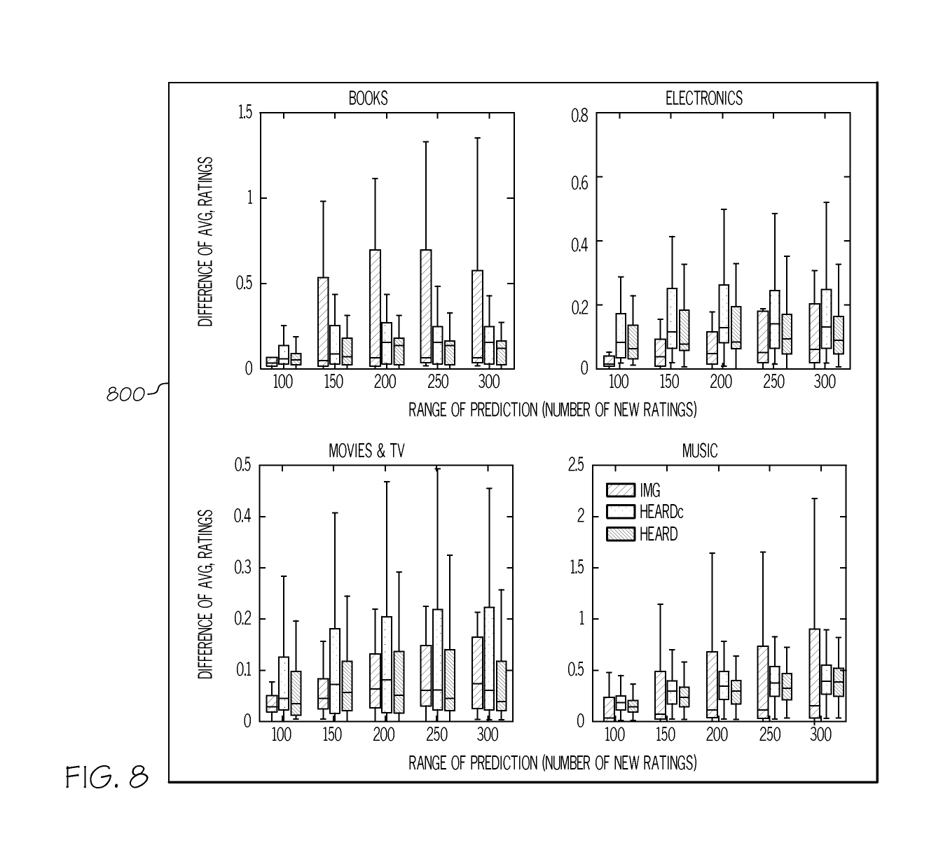

With respect to long-term prediction, the products with at least 500 ratings were selected and the length of rating history (for training) was fixed at 200. Each model was applied to predict the rating distribution after the next M ratings (M is referred to as the prediction range). The accuracy is measured by the difference between predicted and actual average ratings. The performance 800 of the different models is illustrated in FIG. 8, wherein prediction range M was varied from 100 to 300. It is observed that compared with IMG and HEARD_C the prediction accuracy of HEARD is much less sensitive to the setting of M. This can be explained as follows. First, the prediction of IMG depends on the simple statistics (i.e., fraction of ratings at different levels), which however may fluctuate significantly over a large time span. Second, as M increases, the change of the strength of herding effects can no longer be ignored as HEARD_C does. Therefore, HEARD achieves reliable accuracy in both short-term and long-term prediction tasks and accurately captures the growth dynamics of product ratings.

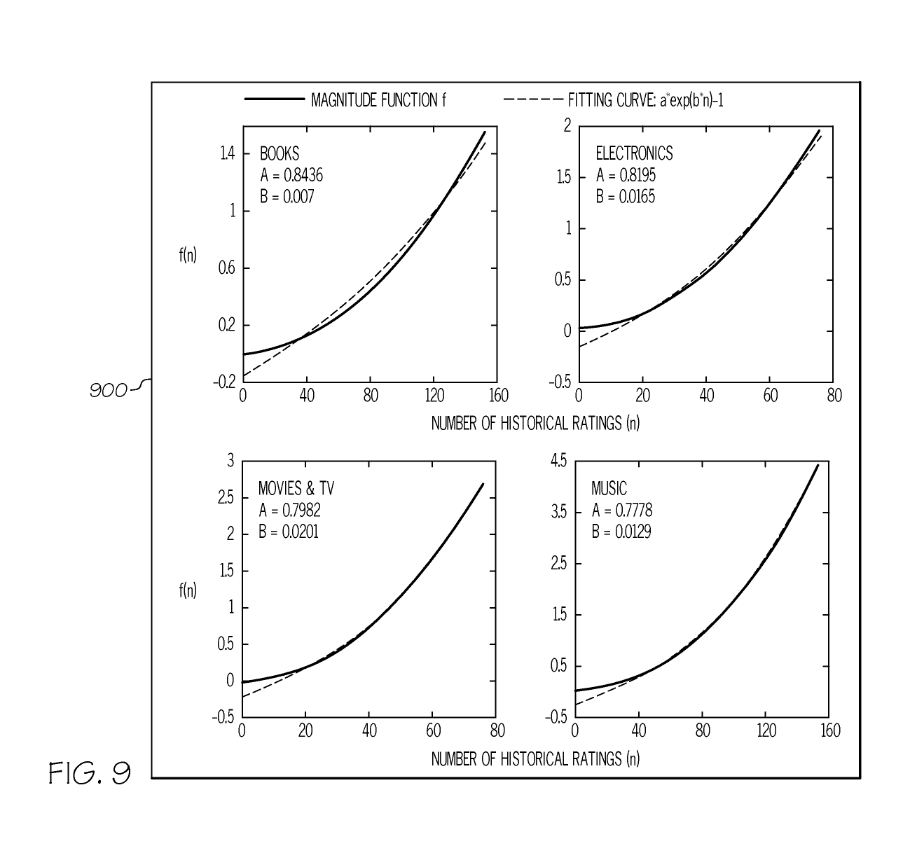

A quantitative study on the herding effects observable in real customer rating data was also performed using the HEARD model as the analytical tool. For each product category, the process discussed above with respect to FIG. 3 was performed to fit the model and examine the herding effects as characterized by the estimated magnitude function ƒ(•) and category-level parameters {θₖ}ₖ. Recall that ƒ(n) specifies the strength of herding effects as a function of the number of historical ratings n. FIG. 9 illustrates the estimated ƒ(n) 900 for each product category. Curve fitting was applied to ƒ(n) with an exponential model a*exp(b*n)−1 (a and b are parameters). The magnitude functions in all four categories tightly follow the exponential curves, despite their slightly different parameter settings of a and b.

This finding entails multi-fold implications: First, it confirms that the strength of herding effects evolves with the cumulative number of historical ratings. Second, it also echoes the results documented by existing experimental studies on the nonlinear relationship between the predictability of individual behaviors and external influence. Third, most importantly, it provides a formula to explicitly quantify the strength of herding effects. For example, comparing the curves for the categories of Books and Movies & TV, it is observed that the herding effects is stronger in the category of Movies & TV, that is, customers are more easily to be influenced by prior ratings when purchasing Movies & TV products. Such information can be valuable for applications such as targeted advertising.

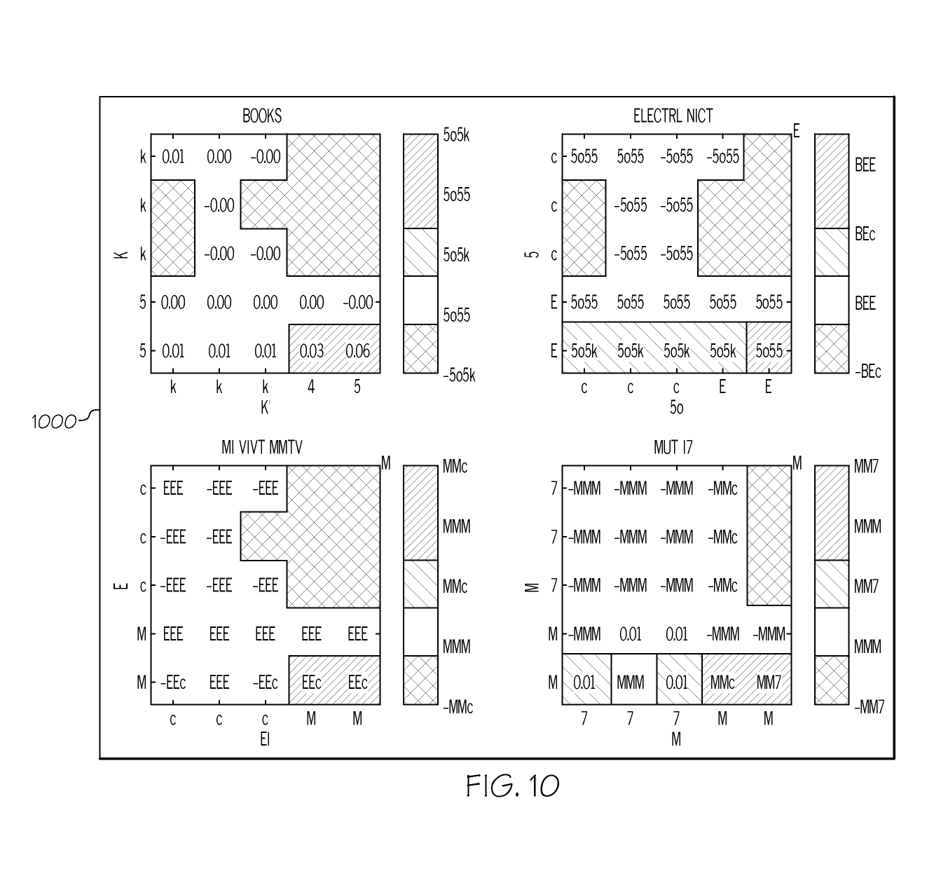

Next, parameters {θₖ} were examined. Recall that these parameters dictate the mutual influence between the ratings at different levels, concretely, with θ_{k,k′} specifying how preceding level-k′ ratings may positively excite or negatively inhibit the generation of level-k ratings. FIG. 10 illustrates the heat maps 1000 of {θₖ} estimated for each product category. While each category has its unique traits, certain common patterns are observed. First, high ratings (e.g., five-star ratings) tend to stimulate new high ratings while inhibiting the generation of low ratings. Second, high ratings are more impactful than low ratings in influencing other ratings. These observations are consistent with the finding of the asymmetric herding effects of positive and negative prior opinions.

As discussed above, the data processor 108 is able to perform various analytical tasks utilizing the HEARD model. Experiments were performed to show how the data processor effectively exposes the rating inherent to the quality of a product (i.e., “intrinsic rating”) by factoring out the herding effects from collective ratings, and (ii) performs predicative, what-if analysis by incorporating artificial conditions into the rating growth dynamics model. To understand the issue that the simple aggregated (or external) rating of a product deviates from its true quality, the HEARD model was applied to estimate the intrinsic ratings and then measure for each product the difference between its intrinsic and external average ratings.

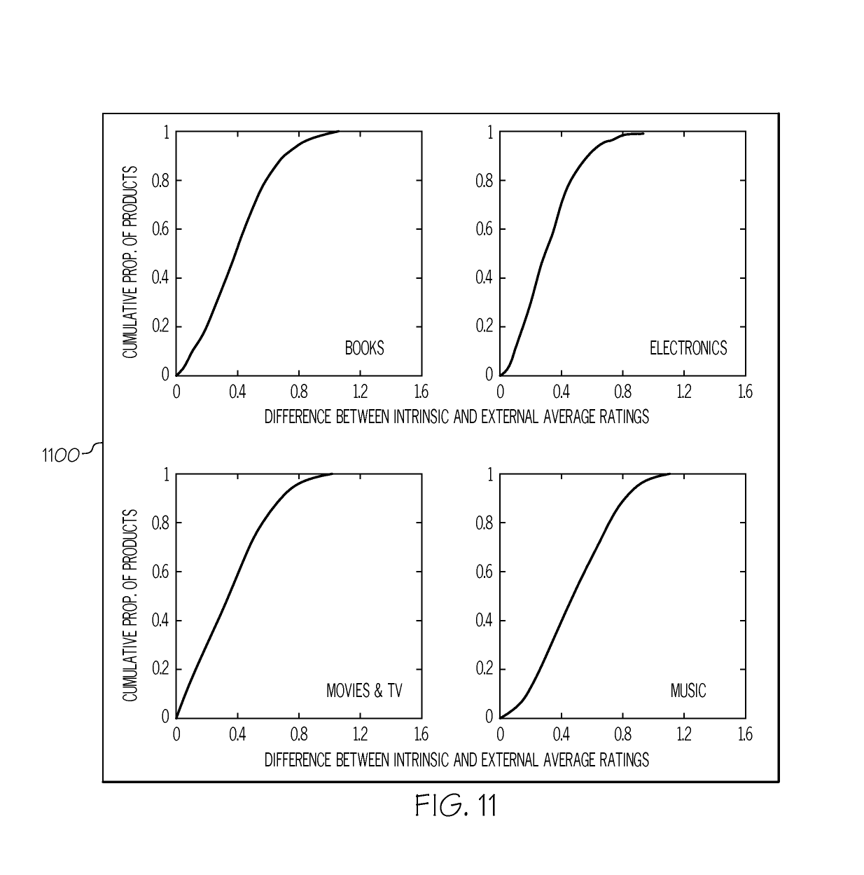

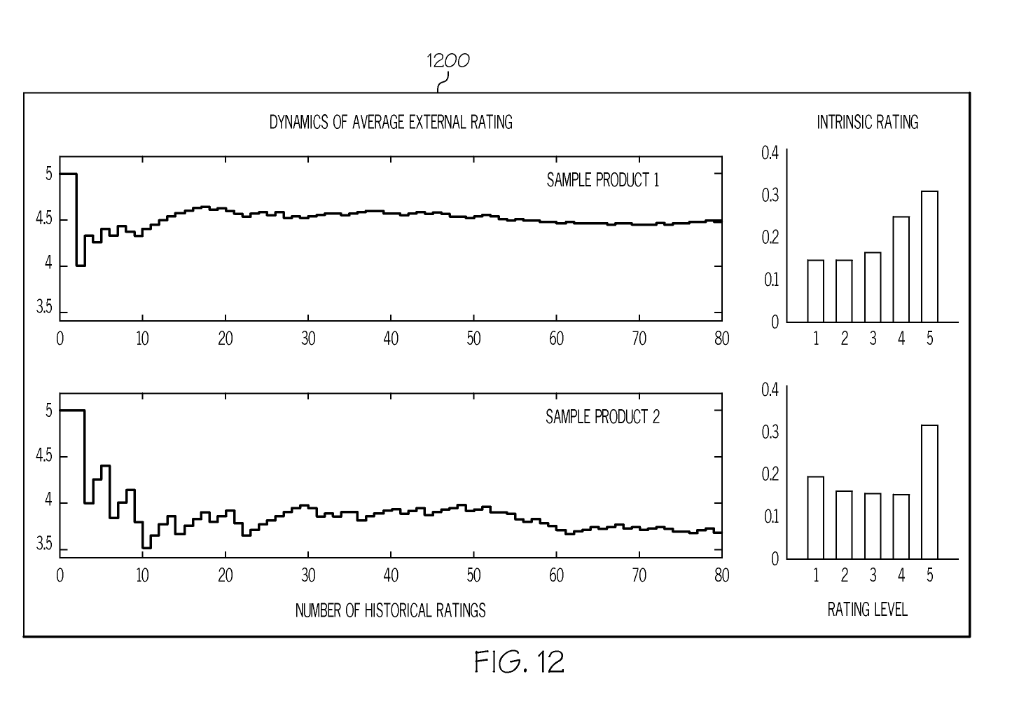

FIG. 11 shows the cumulative proportion of products 1100 with respect to the difference between intrinsic and external ratings in each category. It is observed that in all the cases, over 50% products have their external ratings deviate at least 0.5 from their intrinsic ratings, which is significant considering that the online retailed uses a five-level rating system. Endowed with the capability of exposing the intrinsic rating of a product, the true quality of two products can be compared without being misguided by their external ratings. FIG. 12 showcases such an example, in which the dynamics 1200 of the average external ratings of two sample products is depicted. Despite that they differ significantly in their external ratings (about 0.9), their intrinsic ratings are indeed fairly similar as shown in the right plot. This is explained by that sample product 2 experiences a sequence of low ratings at the early stage of its history, which considerably changes the dynamics of its rating growth. Utilizing the HEARD model, however, the data processor 108 is able to maximally debias this type of influence caused by the herding effects.

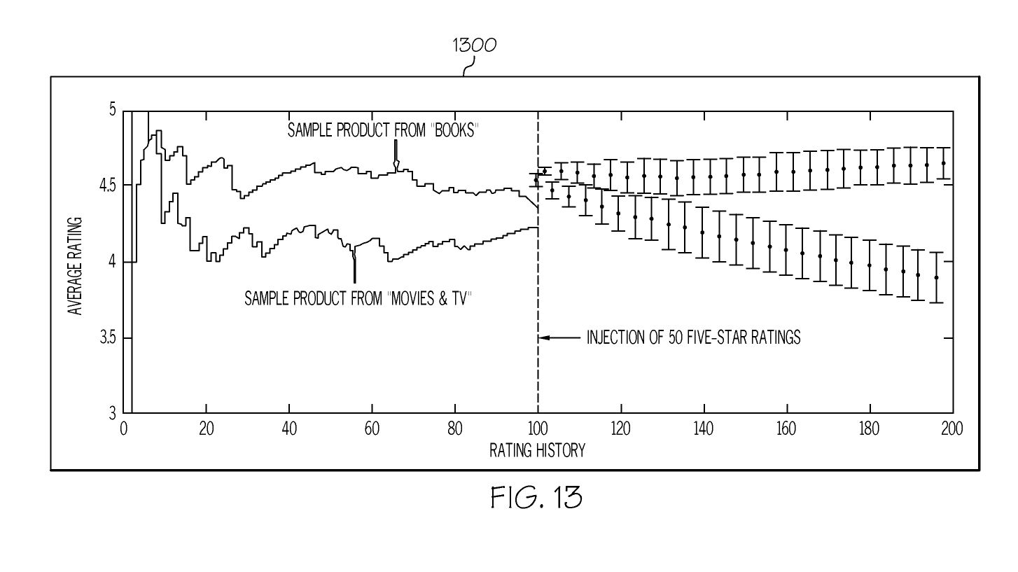

The Markovian nature of the HEARD model enables the data processor 108 to perform predicative, “what-if” analysis by artificially incorporating desired conditions into the prediction model and analyze the consequences using simulation. For example, before deciding whether to invest in a promotion campaign for a product, market analysts may wish to estimate the long-term influence of the burst of high ratings due to the promotion. FIG. 13 shows one concrete example of a what-if analysis 1300 incorporating artificial conditions into the prediction model of one or more embodiments. Two sample products were respectively selected from the categories of Movies & TV and Books, which have fairly close average ratings thus far. Now, assuming the promotion takes effect, 50 five-star ratings were injected into their rating histories. As shown in the right panel of FIG. 13 the prediction by the data processor 108 shows that: while both products experience similar short-term bursts in their popularity, in the long run the promotion has much longer-lasting influence on the sample product from the category of Books. It is clear that this provides valuable information for the decision making of market analysts.

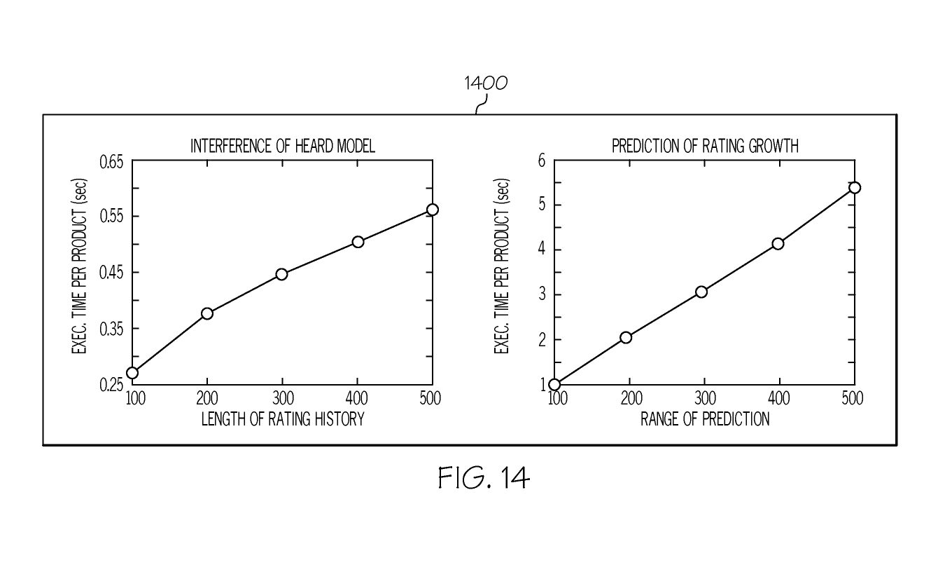

In a last set of experiments, the scalability of the HEARD model was evaluated. Specifically, for model inference, the average execution time per product by the HEARD MODEL under varying length of rating history (for training) was measured. In addition, future rating prediction, its average execution time under varying setting of prediction range was also measured. The results 1400 are depicted in FIG. 14, where it is observed that the execution time of the HEARD model grows approximately linearly with the length of rating history and the range of prediction. This also confirms the complexity of the processes shown in FIG. 3 and FIG. 5. Therefore, the HEARD model scales up to large rating datasets.

Operational Flow Diagram

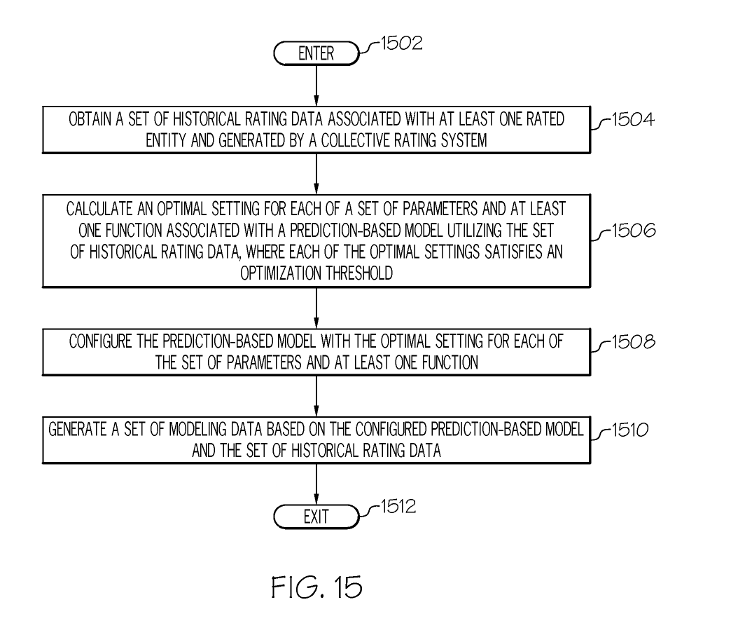

FIG. 15 is an operational flow diagram illustrating one example of a process for quantifying herding effects in one or more collective rating systems. The operational flow diagram of FIG. 15 beings at step 1502 and flows directly to step 1504. The data processor 108, at step 1504, obtains a set of historical rating data 116 associated with at least one rated entity and generated by a collective rating system. The set of historical rating data 116 at least includes a sequence of ratings and a distribution of ratings in the sequence of ratings at each of a set of rating-levels. The data processor 108, at step 1506, calculates an optimal setting for each of a set of parameters and at least one function associated with a prediction-based model 200 utilizing the set of historical rating data 116, where each of the optimal settings satisfies an optimization threshold.

In one embodiment, the prediction-based model 200 is defined as:

$$Pr ( {r}_{i} = k \vert {x}_{i} ) = \frac{exp ( {μ}_{k} + f ( i ) {θ}_{k}^{⊤} {x}_{i} )}{{\sum }_{{k}^{′} = 1}^{K} exp ( {μ}_{{k}^{′}} + f ( i ) {θ}_{{k}^{′}}^{⊤} {x}_{i} )} ,$$

where rᵢ is an i^{th} rating in a sequence of ratings, k is a given rating-level, xᵢ is a rating history, Pr(rᵢ=k|xᵢ) is a likelihood of observing a level-k rating given rating history xᵢ, μ=[μ₁, μ₂, . . . , μ_{K}]^{T}∈ [symbol] ^{K} represents coefficients of an intrinsic distribution related to a true quality of a rated entity, ƒ(•) is a magnitude function describing a relationship between a strength of herding effects and a number of ratings in the rating history, and θₖ∈ [symbol] ^{K} weighs an effect of each of rating in xᵢ at a given rating level on generating a new rating at a given rating-level.

The data processor 108, at step 1508, configures the prediction-based model 200 with the optimal setting for each of the set of parameters and at least one function. The data processor 108, at step 1510 generates a set of modeling data 118 based on the configured prediction-based model 200 and the set of historical rating data 116. The modeling data 118 comprises, for example, one or more of debiasing, prediction, and what-if analysis data. With respect to debiasing, the data processor 108 factors out herding effects from collective ratings to identify the intrinsic quality of an entity (e.g., product, service, individual, business, etc.) being rated. With respect to prediction, the data processor 108 predicts the distribution of an entity's next N ratings given its rating history. When performing a what-if analysis, the data processor 108 determines or predicts how an entity's future ratings would be “herded” if M ratings of a given level were injected into the entity's current ratings. In one embodiment, once the modeling data 118 has been generated it is further operated on to transform it into another form and/or is presented to one or more users via a user interface device(s). The control flow exits at step 1512.

Information Processing System

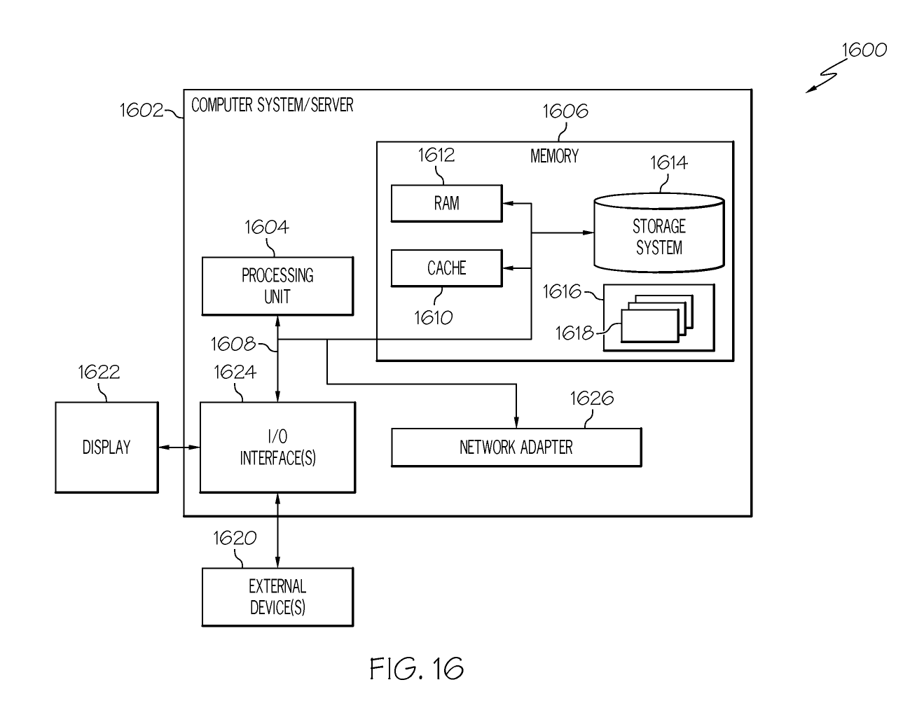

Referring now to FIG. 16, this figure is a block diagram illustrating an information processing system that can be utilized in various embodiments of the present disclosure. The information processing system 1602 is based upon a suitably configured processing system configured to implement one or more embodiments of the present disclosure. Any suitably configured processing system can be used as the information processing system 1602 in embodiments of the present disclosure. In another embodiment, the information processing system 1602 is a special purpose information processing system configured to perform one or more embodiments discussed above. The components of the information processing system 1602 can include, but are not limited to, one or more processors or processing units 1604, a system memory 1606, and a bus 1608 that couples various system components including the system memory 1606 to the processor 1604.

The bus 1608 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 16, the main memory 1606 includes at least the data processor 108 discussed above with respect to FIG. 1. Each of these components can reside within the processor 1604, or be a separate hardware component. The system memory 1606 can also include computer system readable media in the form of volatile memory, such as random access memory (RAM) 1610 and/or cache memory 1612. The information processing system 1602 can further include other removable/non-removable, volatile/non-volatile computer system storage media. By way of example only, a storage system 1614 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1608 by one or more data media interfaces. The memory 1606 can include at least one program product having a set of program modules that are configured to carry out the functions of an embodiment of the present disclosure.

Program/utility 1616, having a set of program modules 1618, may be stored in memory 1606 by way of example, and not limitation, as well as an operating system, one or more application programs, other program modules, and program data. Each of the operating system, one or more application programs, other program modules, and program data or some combination thereof, may include an implementation of a networking environment. Program modules 1618 generally carry out the functions and/or methodologies of embodiments of the present disclosure.

The information processing system 1602 can also communicate with one or more external devices 1620 such as a keyboard, a pointing device, a display 1622, etc.; one or more devices that enable a user to interact with the information processing system 1602; and/or any devices (e.g., network card, modem, etc.) that enable computer system/server 1602 to communicate with one or more other computing devices. Such communication can occur via I/O interfaces 1624. Still yet, the information processing system 1602 can communicate with one or more networks such as a local area network (LAN), a general wide area network (WAN), and/or a public network (e.g., the Internet) via network adapter 1626. As depicted, the network adapter 1626 communicates with the other components of information processing system 1602 via the bus 1608. Other hardware and/or software components can also be used in conjunction with the information processing system 1602. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for quantifying herding effects in one or more collective rating systems, the method comprising:
obtaining a set of historical rating data associated with at least one rated entity and generated by a collective rating system, the set of historical rating data at least comprising a sequence of ratings and a distribution of ratings in the sequence of ratings at each of a set of rating-levels;
calculating, utilizing the set of historical rating data, an optimal setting for each of a set of parameters and at least one function associated with a prediction-based model, wherein each of the optimal settings satisfies an optimization threshold;
configuring the prediction-based model with the optimal setting for each of the set of parameters and at least one function; and
generating, based on the configured prediction-based model and the set of historical rating data, a set of modeling data.

2. The method of claim 1, wherein the calculating comprises:
generating a plurality of sequential prediction tasks based on the set of historical rating data, each of the plurality of sequential prediction tasks being configured to predict at least one rating level for a given rating in the sequence of ratings;
for at least one of the plurality of sequential prediction tasks performing an iterative optimization process, where each iteration of the optimization process is associated with a corresponding sequential prediction task in the plurality of sequential prediction tasks, the iterative optimization process comprising
selecting a setting for each of the set of parameters and the at least one function;
configuring the prediction-based model with the setting selected for each of the set of parameters and the at least one function;
predicting, utilizing the configured prediction-based model and based on a set of known rating-levels for previous ratings in the sequence of ratings, a rating-level for a known rating in the sequence of ratings corresponding to the prediction task;
comparing the predicted rating-level with a rating level of the known rating;
determining, based on the comparing, if the predicted rating-level satisfies the optimization threshold;
based on the predicted rating-level failing to satisfy the optimization threshold, performing a next iteration of the iterative optimization process; and
based on the predicted rating-level satisfying the optimization threshold,
identifying each setting currently selected for the set of parameters and at least one function as the optimal setting.

3. The method of claim 1, wherein the set of parameters comprises
at least a first parameter representing one or more coefficients of an intrinsic distribution related to a true quality of the at least one rated entity, and at least a second parameter that weighs an effect of each of the distributions of ratings at a given rating level on generating a new rating at a given rating-level, and
wherein the at least one function is a magnitude function describing a relationship between a strength of herding effects and a number of ratings in the sequence of ratings.

4. The method of claim 1, wherein the prediction-based model is defined as:
$$Pr ( {r}_{i} = k \vert {x}_{i} ) = \frac{exp ( {μ}_{k} + f ( i ) {θ}_{k}^{⊤} {x}_{i} )}{{\sum }_{{k}^{′} = 1}^{K} exp ( {μ}_{{k}^{′}} + f ( i ) {θ}_{{k}^{′}}^{⊤} {x}_{i} )}$$
where rᵢ is an i^{th} rating in a sequence of ratings, k is a given rating-level, xᵢ is a rating history, Pr(rᵢ=k|xᵢ) is a likelihood of observing a level-k rating given rating history xᵢ, μ=[μ₁, μ₂, . . . , μ_{K}]^{T}∈ [symbol] ^{K} represents coefficients of an intrinsic distribution related to a true quality of a rated entity, ƒ(•) is a magnitude function describing a relationship between a strength of herding effects and a number of ratings in the rating history, and θₖ∈ [symbol] ^{K} weighs an effect of each of rating in xᵢ at a given rating level on generating a new rating at a given rating-level.

5. The method of claim 1, wherein the modeling data comprises an intrinsic quality of the at least one rated entity, the intrinsic quality being calculated based on factoring out herding effects from the sequence of ratings.

6. The method of claim 1, wherein the modeling data comprises a predicted rating growth for the at least one rated entity, the predicted rate growth characterizing a distribution of M subsequent ratings for the at least one rated entity based on its previous N ratings.

7. The method of claim 1, wherein the modeling data comprises one or more predicted trends of future rating growth calculated based on a distribution of M subsequent ratings for the at least one rated entity based on its previous N ratings and X artificial ratings.

8. An information processing system for quantifying herding effects in one or more collective rating systems, the information processing system comprising:
memory;
at least one processor communicatively coupled to the memory; and
a data processor communicatively coupled to the memory and the processor, wherein the data processor is configured to perform a method comprising:
obtaining a set of historical rating data associated with at least one rated entity and generated by a collective rating system, the set of historical rating data at least comprising a sequence of ratings and a distribution of ratings in the sequence of ratings at each of a set of rating-levels;
calculating, utilizing the set of historical rating data, an optimal setting for each of a set of parameters and at least one function associated with a prediction-based model, wherein each of the optimal settings satisfies an optimization threshold;
configuring the prediction-based model with the optimal setting for each of the set of parameters and at least one function; and
generating, based on the configured prediction-based model and the set of historical rating data, a set of modeling data.

9. The information processing system of claim 8, wherein the calculating comprises:
generating a plurality of sequential prediction tasks based on the set of historical rating data, each of the plurality of sequential prediction tasks being configured to predict at least one rating level for a given rating in the sequence of ratings;
for at least one of the plurality of sequential prediction tasks performing an iterative optimization process, where each iteration of the optimization process is associated with a corresponding sequential prediction task in the plurality of sequential prediction tasks, the iterative optimization process comprising
selecting a setting for each of the set of parameters and the at least one function;
configuring the prediction-based model with the setting selected for each of the set of parameters and the at least one function;
predicting, utilizing the configured prediction-based model and based on a set of known rating-levels for previous ratings in the sequence of ratings, a rating-level for a known rating in the sequence of ratings corresponding to the prediction task;
comparing the predicted rating-level with a rating level of the known rating;
determining, based on the comparing, if the predicted rating-level satisfies the optimization threshold;
based on the predicted rating-level failing to satisfy the optimization threshold, performing a next iteration of the iterative optimization process; and
based on the predicted rating-level satisfying the optimization threshold, identifying each setting currently selected for the set of parameters and at least one function as the optimal setting.

10. The information processing system of claim 8, wherein the set of parameters comprises
at least a first parameter representing one or more coefficients of an intrinsic distribution related to a true quality of the at least one rated entity, and at least a second parameter that weighs an effect of each of the distributions of ratings at a given rating level on generating a new rating at a given rating-level, and
wherein the at least one function is a magnitude function describing a relationship between a strength of herding effects and a number of ratings in the sequence of ratings.

11. The information processing system of claim 8, wherein the prediction-based model is defined as:
$$Pr ( {r}_{i} = k \vert {x}_{i} ) = \frac{exp ( {μ}_{k} + f ( i ) {θ}_{k}^{⊤} {x}_{i} )}{{\sum }_{{k}^{′} = 1}^{K} exp ( {μ}_{{k}^{′}} + f ( i ) {θ}_{{k}^{′}}^{⊤} {x}_{i} )}$$
where rᵢ is an i^{th} rating in a sequence of ratings, k is a given rating-level, xᵢ is a rating history, Pr(rᵢ=k|xᵢ) is a likelihood of observing a level-k rating given rating history xᵢ, μ=[μ₁, μ₂, . . . , μ_{K}]^{T}∈ [symbol] ^{K} represents coefficients of an intrinsic distribution related to a true quality of a rated entity, ƒ(•) is a magnitude function describing a relationship between a strength of herding effects and a number of ratings in the rating history, and θₖ∈ [symbol] ^{K} weighs an effect of each of rating in xᵢ at a given rating level on generating a new rating at a given rating-level.

12. The information processing system of claim 8, wherein the modeling data comprises at least one of:
an intrinsic quality of the at least one rated entity, the intrinsic quality being calculated based on factoring out herding effects from the sequence of ratings, and
a predicted rating growth for the at least one rated entity, the predicted rate growth characterizing a distribution of M subsequent ratings for the at least one rated entity based on its previous N ratings.

13. The information processing system of claim 8, wherein the modeling data comprises one or more predicted trends of future rating growth calculated based on a distribution of M subsequent ratings for the at least one rated entity based on its previous N ratings and X artificial ratings.

14. A computer program product for quantifying herding effects in one or more collective rating systems, the computer program product comprising:
a storage medium readable by a processing circuit and storing instructions for execution by the processing circuit for performing a method comprising:
obtaining a set of historical rating data associated with at least one rated entity and generated by a collective rating system, the set of historical rating data at least comprising a sequence of ratings and a distribution of ratings in the sequence of ratings at each of a set of rating-levels;
calculating, utilizing the set of historical rating data, an optimal setting for each of a set of parameters and at least one function associated with a prediction-based model, wherein each of the optimal settings satisfies an optimization threshold;
configuring the prediction-based model with the optimal setting for each of the set of parameters and at least one function; and
generating, based on the configured prediction-based model and the set of historical rating data, a set of modeling data.

15. The computer program product of claim 14, wherein the calculating comprises:
generating a plurality of sequential prediction tasks based on the set of historical rating data, each of the plurality of sequential prediction tasks being configured to predict at least one rating level for a given rating in the sequence of ratings;
for at least one of the plurality of sequential prediction tasks performing an iterative optimization process, where each iteration of the optimization process is associated with a corresponding sequential prediction task in the plurality of sequential prediction tasks, the iterative optimization process comprising
selecting a setting for each of the set of parameters and the at least one function;
configuring the prediction-based model with the setting selected for each of the set of parameters and the at least one function;
predicting, utilizing the configured prediction-based model and based on a set of known rating-levels for previous ratings in the sequence of ratings, a rating-level for a known rating in the sequence of ratings corresponding to the prediction task;
comparing the predicted rating-level with a rating level of the known rating;
determining, based on the comparing, if the predicted rating-level satisfies the optimization threshold;
based on the predicted rating-level failing to satisfy the optimization threshold, performing a next iteration of the iterative optimization process; and
based on the predicted rating-level satisfying the optimization threshold, identifying each setting currently selected for the set of parameters and at least one function as the optimal setting.

16. The computer program product of claim 14, wherein the set of parameters comprises
at least a first parameter representing one or more coefficients of an intrinsic distribution related to a true quality of the at least one rated entity, and at least a second parameter that weighs an effect of each of the distributions of ratings at a given rating level on generating a new rating at a given rating-level, and
wherein the at least one function is a magnitude function describing a relationship between a strength of herding effects and a number of ratings in the sequence of ratings.

17. The computer program product of claim 14, wherein the prediction-based model is defined as:
$$Pr ( {r}_{i} = k \vert {x}_{i} ) = \frac{exp ( {μ}_{k} + f ( i ) {θ}_{k}^{⊤} {x}_{i} )}{{\sum }_{{k}^{′} = 1}^{K} exp ( {μ}_{{k}^{′}} + f ( i ) {θ}_{{k}^{′}}^{⊤} {x}_{i} )}$$
where rᵢ is an i^{th} rating in a sequence of ratings, k is a given rating-level, xᵢ is a rating history, Pr(rᵢ=k|xᵢ) is a likelihood of observing a level-k rating given rating history xᵢ, μ=[μ₁, μ₂, . . . , μ_{K}]^{T}∈ [symbol] ^{K} represents coefficients of an intrinsic distribution related to a true quality of a rated entity, ƒ(•) is a magnitude function describing a relationship between a strength of herding effects and a number of ratings in the rating history, and θₖ∈ [symbol] ^{K} weighs an effect of each of rating in xᵢ at a given rating level on generating a new rating at a given rating-level.

18. The computer program product of claim 14, wherein the modeling data comprises an intrinsic quality of the at least one rated entity, the intrinsic quality being calculated based on factoring out herding effects from the sequence of ratings.

19. The computer program product of claim 14, wherein the modeling data comprises a predicted rating growth for the at least one rated entity, the predicted rate growth characterizing a distribution of M subsequent ratings for the at least one rated entity based on its previous N ratings.

20. The computer program product of claim 14, wherein the modeling data comprises one or more predicted trends of future rating growth calculated based on a distribution of M subsequent ratings for the at least one rated entity based on its previous N ratings and X artificial ratings.
